(19) United States
(12) Patent Application Publication
(10) Pub. No.: US 2023/0021263 A1
(43) Pub. Date: Jan. 19, 2023

(54) ENERGY STORAGE APPARATUS

(71) Applicant: GS Yuasa International Ltd., Kyoto-shi (JP)

(72) Inventors: Yasuyuki IWASHIMA, Kyoto-shi, Kyoto (JP); Atsuyuki KONISHI, Kyoto-shi, Kyoto (JP); Koki MAEDA, Kyoto-shi, Kyoto (JP)

(21) Appl. No.: 17/782,259

(22) PCT Filed: Jan. 7, 2021
(86) PCT No.: PCT/JP2021/000371

§ 371 Date: Jun. 3, 2022

(30) Foreign Application Priority Data
Jan. 17, 2020 (JP) 2020-005985

(51) Int. Cl. H01M 50/262

(52) U.S. Cl. CPC H01M 50/262; H01G 2/02

(57) ABSTRACT

An energy storage apparatus includes: two energy storage devices each including an electrode assembly formed by stacking in a stacking direction and a metal case in which the electrode assembly is accommodated, the two energy storage devices including a first energy storage device and a second energy storage device that are arrayed in an array direction intersecting the stacking direction; and a pair of restraint bodies that collectively sandwiches the first energy storage device and the second energy storage device in the stacking direction.

### TECHNICAL FIELD

The present invention relates to an energy storage apparatus including a plurality of energy storage devices.

### BACKGROUND ART

Conventionally, there has been known an energy storage apparatus including a plurality of energy storage devices and a pair of restraint bodies that sandwiches the plurality of energy storage devices in a direction intersecting an array direction of the energy storage devices. Patent Document 1 discloses a battery module (energy storage apparatus), in which a pair of end plates (restraint bodies) is disposed at ends in a direction intersecting an array direction of a plurality of battery cells (energy storage devices) and the end plates are connected to each other by a restraint plate and a restraint band.

### PRIOR ART DOCUMENT

### Patent Document

Patent Document 1: JP-A-2018-97983

### SUMMARY OF THE INVENTION

### Problems to be Solved by the Invention

When swelling of a plurality of energy storage devices is prevented by sandwiching the plurality of energy storage devices between a pair of restraint bodies in a direction intersecting an array direction of the plurality of energy storage devices, a configuration capable of easily preventing the swelling of the plurality of energy storage devices is desired.

An object of the present invention is to provide an energy storage apparatus that can easily prevent swelling of a plurality of energy storage devices.

### Means for Solving the Problems

An energy storage apparatus according to an aspect of the present invention includes: two energy storage devices each of which includes an electrode assembly formed by stacking plates in a stacking direction and a metal case in which the electrode assembly is accommodated, the two energy storage devices including a first energy storage device and a second energy storage device that are arrayed in an array direction intersecting the stacking direction; and a pair of restraint bodies that collectively sandwich the first energy storage device and the second energy storage device in the stacking direction, the pair of restraint bodies being directly joined to each other.

The present invention can be implemented not only as an energy storage apparatus but also as a pair of restraint bodies.

### Advantages of the Invention

According to an energy storage apparatus of the present invention, swelling of a plurality of energy storage devices can be easily prevented.

### BRIEF DESCRIPTION OF THE DRAWINGS

FIG. 1 is a perspective view illustrating an appearance of an energy storage apparatus according to an embodiment.

FIG. 2 is a perspective view illustrating an inside of an outer case by separating a body and a lid of the outer case from each other in the energy storage apparatus according to the embodiment.

FIG. 3 is an exploded perspective view illustrating each component when the energy storage unit of the embodiment is disassembled.

FIG. 4 is an exploded perspective view illustrating each component when an energy storage device of the embodiment is disassembled.

FIG. 5 is a sectional view illustrating a configuration of the energy storage unit of the embodiment together with a reinforcing member.

FIG. 6 is a sectional view illustrating the configuration of the energy storage unit of the embodiment together with the reinforcing member and an outer case body.

FIG. 7 is a sectional view illustrating the configuration of the energy storage unit of the embodiment together with other components.

### MODE FOR CARRYING OUT THE INVENTION

In the conventional energy storage apparatus, swelling of a plurality of energy storage devices is prevented by sandwiching the plurality of energy storage devices between a pair of restraint bodies in a direction intersecting an array direction of the energy storage devices. However, in the conventional energy storage apparatus, a member (a restraint plate and a restraint band) for connecting the pair of restraint bodies to each other is required, so that a configuration of the energy storage apparatus becomes complicated. As described above, when the swelling of the plurality of energy storage devices is prevented by sandwiching the plurality of energy storage devices between the pair of restraint bodies in the direction intersecting the array direction of the plurality of energy storage devices, the configuration capable of easily preventing the swelling of the plurality of energy storage devices is desired.

The present invention has been made by the inventor of the present application to newly focus on the above problems, and an object of the present invention is to provide an energy storage apparatus that can easily prevent the swelling of the plurality of energy storage devices.

In order to achieve the object, an energy storage apparatus according to one aspect of the present invention includes: two energy storage devices each of which includes an electrode assembly formed by stacking plates in a stacking direction and a metal case in which the electrode assembly is accommodated, the two energy storage devices including a first energy storage device and a second energy storage device that are arrayed in an array direction intersecting the stacking direction; and a pair of restraint bodies that collectively sandwiches the first energy storage device and the second energy storage device in the stacking direction, the pair of restraint bodies being directly joined to each other.

Thus, in the energy storage apparatus, the first energy storage device and the second energy storage device include metal cases, and are arrayed in the array direction that intersects the stacking direction of the plate of the electrode assembly, and the pair of restraint bodies are directly joined to collectively sandwich the first energy storage device and the second energy storage device in the stacking direction. In this way, the configuration can be simplified by collectively sandwiching the first energy storage device and the second energy storage device by the pair of restraint bodies. The pair of restraint bodies is directly joined in order to firmly sandwich the first energy storage device and the second energy storage device between the pair of restraint bodies. Thus, it is possible to reduce the risk that the number of joining places is reduced to loosen the joining portions, and the number of components can also be reduced, so that the configuration can be simplified. As described above, in the configuration in which the plurality of energy storage devices (the first energy storage device and the second energy storage device) are sandwiched between the pair of restraint bodies in the direction intersecting the array direction of the energy storage devices, the swelling of the plurality of energy storage devices can be easily prevented.

The pair of restraint bodies may be directly joined at a position sandwiching the first energy storage device and the second energy storage device in the array direction.

Thus, the pair of restraint bodies is directly joined at the positions where the first energy storage device and the second energy storage device are sandwiched in the array direction of the first energy storage device and the second energy storage device, so that the first energy storage device and the second energy storage device can be easily and collectively sandwiched. Thus, the swelling of the plurality of energy storage devices (the first energy storage device and the second energy storage device) can be easily prevented by the pair of restraint bodies.

The pair of restraint bodies may be directly joined between the first energy storage device and the second energy storage device.

Accordingly, the pair of restraint bodies is directly joined between the first energy storage device and the second energy storage device, so that each of the first energy storage device and the second energy storage device can be sandwiched easily and more firmly. Thus, the swelling of the plurality of energy storage devices (the first energy storage device and the second energy storage device) can be easily prevented by the pair of restraint bodies.

At least one of the pair of restraint bodies may include a protrusion that protrudes toward the other of the pair of restraint bodies, is disposed between the first energy storage device and the second energy storage device, and is directly joined to the other of the pair of restraint bodies between the first energy storage device and the second energy storage device.

Accordingly, the protrusion is formed in at least one of the pair of restraint bodies and joined to the other restraint body, so that the pair of restraint bodies can be directly joined between the first energy storage device and the second energy storage device with the simple configuration. Consequently, the swelling of the plurality of energy storage devices (the first energy storage device and the second energy storage device) can be easily prevented.

The energy storage apparatus further includes a third energy storage device disposed at a position where the second energy storage device is sandwiched between the third energy storage device and the first energy storage device in the array direction, and the pair of restraint bodies may be directly joined between the second energy storage device and the third energy storage device.

Accordingly, the pair of restraint bodies is also directly joined between the second energy storage device and the third energy storage device, so that each of the first energy storage device, the second energy storage device, and the third energy storage device can be sandwiched easily and more firmly. Consequently, the swelling of the plurality of energy storage devices (the first energy storage device, the second energy storage device, and the third energy storage device) can be easily prevented by the pair of restraint bodies.

The energy storage apparatus further includes a plurality of the first energy storage devices arranged in the stacking direction and a plurality of the second energy storage devices arranged in the stacking direction, and the pair of restraint bodies may collectively sandwich the plurality of first energy storage devices and the plurality of second energy storage devices in the stacking direction.

Accordingly, in the configuration in which the plurality of first energy storage devices and the plurality of second energy storage devices are arranged in the stacking direction, the pair of restraint bodies collectively sandwiches the plurality of first energy storage devices and the plurality of second energy storage devices in the stacking direction. Consequently, the plurality of first energy storage devices and the plurality of second energy storage devices can be easily and collectively sandwiched between the pair of restraint bodies, so that the swelling of the plurality of first energy storage devices and the plurality of second energy storage devices can be easily prevented.

The energy storage apparatus further includes an outer case that accommodates the first energy storage device and the second energy storage device, and at least one of the pair of restraint bodies may be fixed to the outer case.

Accordingly, at least one of the pair of restraint bodies is fixed to the outer case, so that the first energy storage device and the second energy storage device can be easily fixed to the outer case. Consequently, even when the vibration, the impact, or the like is applied to the energy storage apparatus, movement of the first energy storage device and the second energy storage device can be easily prevented in the outer case.

An energy storage apparatus according to another aspect of the present invention includes: two energy storage devices each including an electrode assembly formed by stacking plates in a stacking direction, the two energy storage devices including a first energy storage device and a second energy storage device that are arrayed in an array direction intersecting the stacking direction; a pair of restraint bodies that collectively sandwich the first energy storage device and the second energy storage device in the stacking direction, the pair of restraint bodies being joined to each other; and an outer case that accommodates the first energy storage device and the second energy storage device, and at least one of the pair of restraint bodies is fixed to the outer case.

Thus, in the energy storage apparatus, the first energy storage device and the second energy storage device are arrayed in the array direction intersecting the stacking direction of the plate of the electrode assembly, and the pair of restraint bodies collectively sandwiches the first energy storage device and the second energy storage device in the stacking direction and at least one of the pair of restraint bodies is fixed to the outer case. In this way, the configuration can be simplified by collectively sandwiching the first energy storage device and the second energy storage device by the pair of restraint bodies. At least one of the pair of restraint bodies is fixed to the outer case, so that the movement of the first energy storage device and the second energy storage device can be easily prevented in the outer case even when vibration, impact, or the like is applied to the energy storage apparatus. As described above, in the configuration in which the plurality of energy storage devices (the first energy storage device and the second energy storage device) are sandwiched between the pair of restraint bodies in the direction intersecting the array direction of the energy storage devices, the movement of the plurality of energy storage devices can be easily prevented in the outer case while the swelling of the plurality of energy storage devices is prevented.

At least one of the pair of restraint bodies may be fixed to the outer case between the first energy storage device and the second energy storage device.

Accordingly, at least one of the pair of restraint bodies is fixed to the outer case between the first energy storage device and the second energy storage device, so that the first energy storage device and the second energy storage device can be fixed to the outer case in a well-balanced manner. Consequently, even when the vibration, the impact, or the like is applied to the energy storage apparatus, the movement of the first energy storage device and the second energy storage device can be more prevented in the outer case.

Hereinafter, an energy storage apparatus according to an embodiment (including a modification of the present invention) will be described with reference to the drawings. The embodiment described below illustrates a comprehensive or specific example. Numerical values, shapes, materials, components, dispositions and connection forms of the components, manufacturing processes, order of the manufacturing processes, and the like described in the following embodiment are merely examples, and are not intended to limit the present invention. In each of the drawings, dimensions and the like are not strictly illustrated. In the drawings, the same or similar components are denoted by the same reference signs.

In the following description and drawings, a longitudinal direction of the outer case of the energy storage apparatus, an extending direction of the reinforcing member and the protrusion thereof, an array direction of the plurality of energy storage devices such as the first energy storage device and the second energy storage device, an arranging direction of the energy storage devices and electric equipment, an extending direction of the restraint body, a direction in which short side surfaces of the cases of the energy storage devices are opposite to each other, or an arranging direction of a pair of electrode terminals in one energy storage device is defined as an X-axis direction. An arrangement direction of the protrusion of the reinforcing member or an arrangement direction of the body and the lid of the case of the energy storage device is defined as a Y-axis direction. A direction in which the body and the lid of the outer case are arranged, a direction in which the pair of restraint bodies are arranged, a direction in which the energy storage device, the restraint body, and the reinforcing member are arranged, a direction in which long side surfaces of the cases of the energy storage devices are opposite to each other, the stacking direction of the plates of the electrode assembly of the energy storage device, or a vertical direction is defined as a Z-axis direction. The X-axis direction, the Y-axis direction, and the Z-axis direction are directions intersecting one another (orthogonal to one another in the embodiment). Although it may be conceivable that the Z-axis direction is not in the vertical direction depending on a mode of use, hereinafter the Z-axis direction is described as the vertical direction for convenience of explanation.

In the following description, an X-axis positive direction indicates an arrow direction side of the X-axis, and an X-axis negative direction indicates an opposite direction to the X-axis positive direction. The same applies to the Y-axis direction and the Z-axis direction. An expression indicating a relative direction or a posture such as parallel and orthogonal strictly also includes the case where the expression is not the direction or the posture. For example, two directions orthogonal to each other means not only that the two directions are completely orthogonal to each other, but also that the two directions are substantially orthogonal to each other, namely, includes a difference of, for example, about several percent.

### Embodiment

[1 General Description of Energy Storage Apparatus 10]

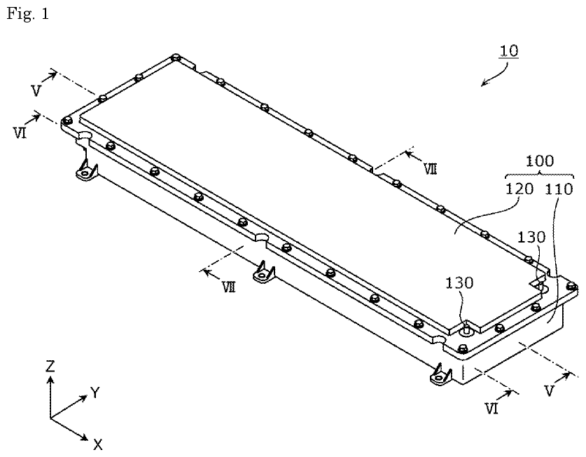

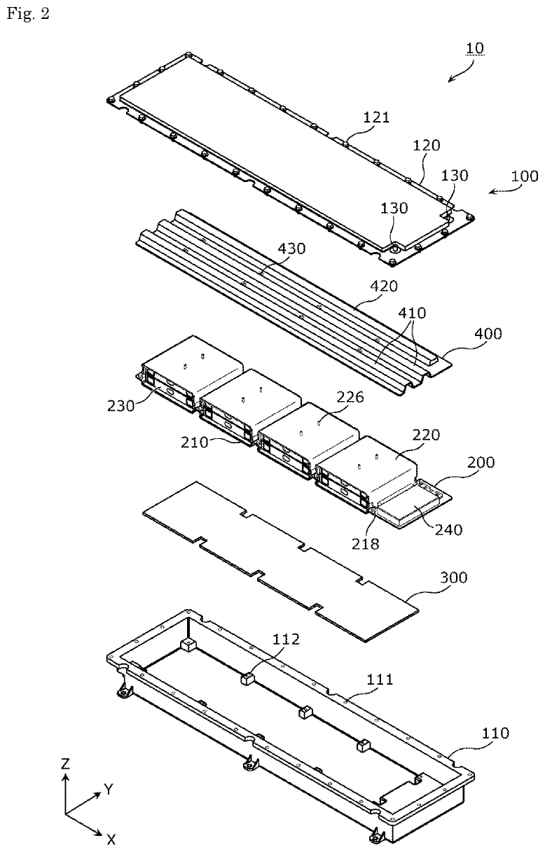

A configuration of an energy storage apparatus 10 according to an embodiment will be described. FIG. 1 is a perspective view illustrating an appearance of the energy storage apparatus 10 of the embodiment. FIG. 2 is a perspective view illustrating an inside of an outer case 100 by separating a body and a lid of the outer case 100 from each other in the energy storage apparatus 10 of the embodiment.

The energy storage apparatus 10 is an apparatus capable of charging electricity from the outside and discharging electricity to the outside, and has a substantially rectangular parallelepiped shape in the embodiment. The energy storage apparatus 10 is a battery module (assembled battery) used for a power storage application, a power supply application, and the like. Specifically, for example, the energy storage apparatus 10 is used as a battery for driving a moving body such as automobiles, motorcycles, watercrafts, vessels, snowmobiles, agricultural machines, construction machines, and railway vehicles for electric railway or starting an engine. Examples of the automobiles include an electric vehicle (EV), a hybrid electric vehicle (HEV), a plug-in hybrid electric vehicle (PHEV), and a gasoline automobile. Examples of the railway vehicles for electric railway include a train, a monorail, and a linear motor car. The energy storage apparatus 10 can also be used as a stationary battery or the like used for home use, a generator, or the like.

As illustrated in FIGS. 1 and 2, the energy storage apparatus 10 includes an outer case 100, an energy storage unit 200 accommodated in the outer case 100, a heat insulating sheet 300, and a reinforcing member 400. The energy storage unit 200 also includes a bus bar or the like that electrically connects the energy storage unit 200 to an external terminal 130 to be described later, but illustration and detailed description thereof are omitted.

The outer case 100 is a rectangular (substantially rectangular parallelepiped shape) case (module case) constituting the outer case of the energy storage apparatus 10. That is, the outer case 100 is disposed outside the energy storage unit 200, the heat insulating sheet 300, the reinforcing member 400, and the like, fixes the energy storage unit 200 and the like at predetermined positions, and protects the energy storage unit 200 and the like from impact and the like. The outer case 100 is formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), an ABS resin, or a composite material thereof or an insulation-coated metal. This enables the outer case 100 to prevent the energy storage unit 200 and the like from contacting with a metal member of the outside and the like. The outer case 100 may be formed by a conductive member such as metal as long as electrical insulation properties of the energy storage unit 200 and the like are maintained.

The outer case 100 includes an outer case body 110 constituting a body of the outer case 100 and an outer case lid 120 constituting a lid of the outer case 100. The outer case body 110 is a bottomed rectangular cylindrical housing in which an opening is formed on a Z-axis positive direction side. The outer case lid 120 is a flat rectangular lid that is disposed in a Z-axis positive direction of the outer case body 110, connected to the outer case body 110, and closes the opening of the outer case body 110. The outer case body 110 and the outer case lid 120 may be made of a member made of the same material, or made of members made of different materials.

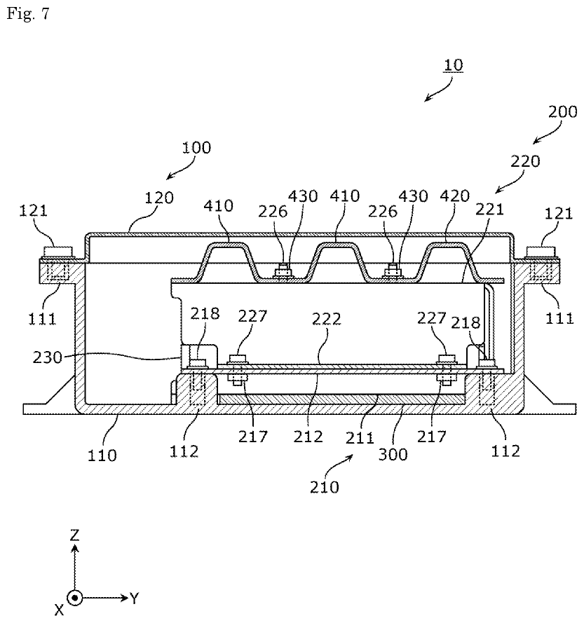

The outer case body 110 includes a body-side connecting unit 111 and an outer case fixing unit 112, and the outer case lid 120 includes a lid-side connecting unit 121. The body-side connecting unit 111 and the lid-side connecting unit 121 are units that are connected (joined) to each other and connect (join) the outer case body 110 and the outer case lid 120 to each other (see FIG. 7). In the embodiment, a plurality of body-side connecting units 111 are arranged at substantially equal intervals on the outer periphery of the outer case body 110, and a plurality of lid-side connecting units 121 are arranged at positions corresponding to the body-side connecting units 111 on the outer periphery of the outer case lid 120.

The lid-side connecting unit 121 is a bolt portion, and the body-side connecting unit 111 is a nut portion to which the bolt portion is screwed. That is, the lid-side connecting unit 121 has a through-hole and a bolt inserted into the through-hole, and the body-side connecting unit 111 has a recess and a nut (insert nut) disposed in the recess (see FIG. 7). The body-side connecting unit 111 may be a bolt portion, and the lid-side connecting unit 121 may be a nut portion to which the bolt portion is screwed. The technique of connecting (joining) the outer case body 110 and the outer case lid 120 to each other may be another technique such as adhesion, heat sealing, ultrasonic welding, welding, or caulking joining.

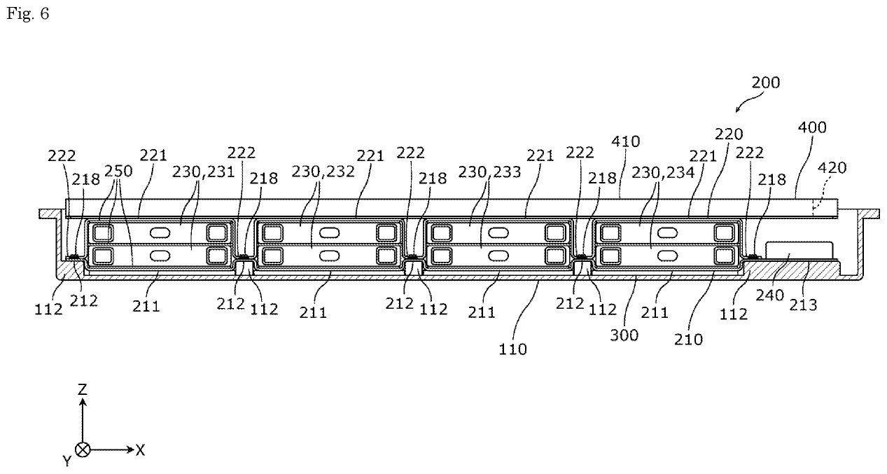

The outer case fixing unit 112 is a member to which the energy storage unit 200 is fixed. That is, at least one of the pair of restraint bodies (a first restraint body 210 and a second restraint body 220) included in the energy storage unit 200 is connected (joined) to the outer case fixing unit 112, whereby at least one of the pair of restraint bodies is fixed to the outer case 100. In the embodiment, a first restraint body fixing unit 218 of the first restraint body 210 to be described later is connected (joined) to the outer case fixing unit 112, whereby the first restraint body 210 (energy storage unit 200) is fixed to the outer case body 110 (see FIGS. 6 and 7).

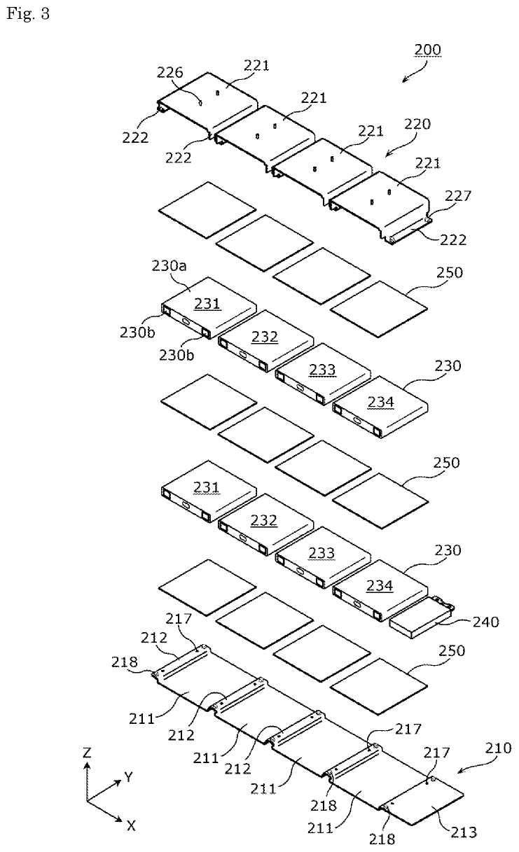

Specifically, the plurality of outer case fixing units 112 are arranged at substantially equal intervals in the periphery of the internal space of the outer case body 110. The plurality of first restraint body fixing units 218 are arranged at positions corresponding to the outer case fixing units 112 of the first restraint body 210 (see FIG. 3). Arrangement positions and the number of the outer case fixing unit 112 and the first restraint body fixing unit 218 are not particularly limited.

The first restraint body fixing unit 218 is a bolt portion, and the outer case fixing unit 112 is a nut portion to which the bolt portion is screwed. That is, the first restraint body fixing unit 218 includes a through-hole and a bolt that is inserted into the through-hole, and the outer case fixing unit 112 includes a recess and a nut (insert nut) that is disposed in the recess (see FIG. 7). The outer case fixing unit 112 may be a bolt portion, and the first restraint body fixing unit 218 may be a nut portion to which the bolt portion is screwed. The technique of fixing the first restraint body 210 (energy storage unit 200) to the outer case body 110 may be another technique, and may be welding, caulked joining, adhesion, fusion bonding, or the like.

External terminals 130 that are a pair of module terminals (total terminals) on a positive electrode side and a negative electrode side are disposed at an end on an X-axis positive direction side in the outer case lid 120. The external terminal 130 are electrically connected to the plurality of energy storage devices 230 included in the energy storage unit 200 through a bus bar or the like (not illustrated), and the energy storage apparatus 10 charges the electricity from the outside through the external terminals 130, and discharges the electricity to the outside through the external terminals 130. The external terminal 130 may be made of a metal conductive member such as copper, a copper alloy, aluminum, and an aluminum alloy.

In the energy storage unit 200, the plurality of energy storage devices 230 are stacked horizontally in the Z-axis direction while horizontally disposed (laid down), the plurality of energy storage devices 230 are arrayed in the X-axis direction, and the electric devices 240 are also arrayed in the X-axis direction, whereby the energy storage unit 200 has a shape that is flat in the Z-axis direction and elongated in the X-axis direction. Specifically, the energy storage unit 200 has a configuration in which the first restraint body 210 and the second restraint body 220 that are the pair of restraint bodies sandwich in the Z-axis direction the plurality of energy storage devices 230 arrayed in the Z-axis direction and the X-axis direction, thereby restraining the plurality of energy storage devices 230 in the Z-axis direction. The detailed description of the configuration of the energy storage unit 200 will be described later.

The heat insulating sheet 300 is a heat-insulating sheet member that is disposed between the outer case body 110 and the energy storage unit 200 and insulates heat generated from the energy storage unit 200. The heat insulating sheet 300 has a shape elongated in the X-axis direction corresponding to the energy storage unit 200 when viewed in the Z-axis direction. The heat insulating sheet 300 may be made of any material as long as it is a member having the heat insulating property, and a dammar material formed by stacking and bonding mica pieces can be cited as an example.

The reinforcing member 400 is a plate-like member that is disposed between the outer case lid 120 and the energy storage unit 200, namely, in the Z-axis positive direction of the energy storage unit 200 and reinforces the energy storage unit 200. The reinforcing member 400 has a shape elongated in the X-axis direction corresponding to the energy storage unit 200 as viewed in the Z-axis direction.

The reinforcing member 400 includes reinforcing member protrusions 410 and 420 and a reinforcing member fixing unit 430. The reinforcing member protrusions 410 and 420 are long protrusions (protruding strips) that protrude in the Z-axis positive direction and extend in the X-axis direction. Specifically, the reinforcing member protrusions 410 and 420 are swelling portions in which the surface on the Z-axis negative direction side of the reinforcing member 400 is recessed in the Z-axis positive direction while the surface on the Z-axis positive direction side of the reinforcing member 400 swells so as to protrude in the Z-axis positive direction. That is, the reinforcing member 400 has a corrugated plate shape formed by bending a plate-like member a plurality of times in the Z-axis positive direction and the Z-axis negative direction. It can be said that the reinforcing member protrusions 410 and 420 are recesses because the surface on the Z-axis negative direction side of the reinforcing member 400 is recessed in the Z-axis positive direction.

In the embodiment, the reinforcing member 400 includes two reinforcing member protrusions 410 disposed on the Y-axis negative direction side and at the center in the Y-axis direction, and one reinforcing member protrusion 420 disposed on the Y-axis positive direction side. The reinforcing member protrusion 410 is formed to continuously and linearly extend from an end edge on the X-axis negative direction side to an end edge on the X-axis positive direction side of the reinforcing member 400. That is, both ends of the reinforcing member 400 in the X-axis direction are opened in the reinforcing member protrusion 410. The reinforcing member protrusion 420 is continuously and linearly extended from the end edge on the X-axis negative direction side to the end on the X-axis positive direction side of the reinforcing member 400, but is not extended to the end edge on the X-axis positive direction side. That is, the reinforcing member protrusion 420 is formed such that the end in the X-axis negative direction of the reinforcing member 400 is opened and the end in the X-axis positive direction is closed. As described above, the bus bars (not illustrated) connected to the external terminals 130 can be disposed by preventing the ends on the X-axis positive direction side and the Y-axis positive direction side of the reinforcing member 400 from protruding in the Z-axis positive direction.

Depending on the disposition position of the bus bar, the reinforcing member protrusion 420 may extend to the end edge on the X-axis positive direction side of the reinforcing member 400 or the reinforcing member protrusions 410 may not extend to the end edge on the X-axis positive direction side of the reinforcing member 400. The reinforcing member protrusions 410 and 420 may not extend to the end edge on the X-axis negative direction side of the reinforcing member 400. In the embodiment, the reinforcing member protrusions 410 and 420 have a trapezoidal shape when viewed from the X-axis direction, but may have any shape such as a polygonal shape other than the trapezoidal shape such as a rectangular shape or a triangular shape, a semicircular shape, a semi-elliptical shape, or a semi-oval shape when viewed from the X-axis direction.

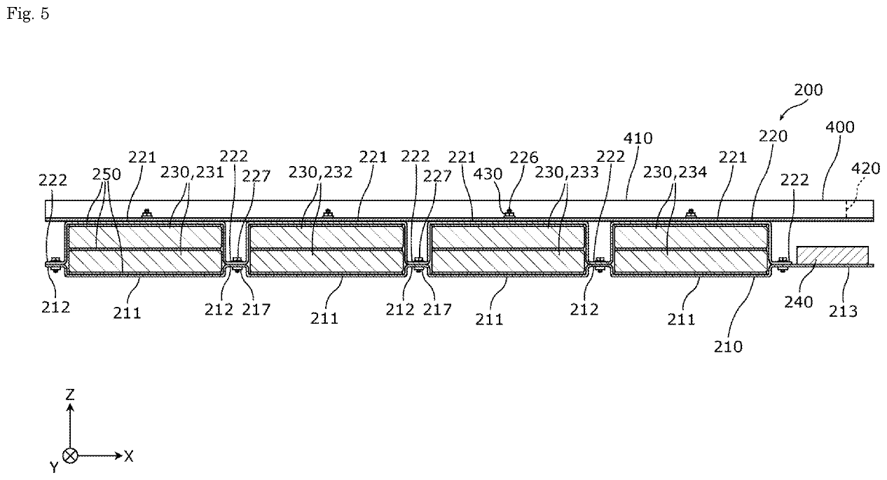

The reinforcing member fixing unit 430 is a member fixed to the energy storage unit 200. That is, the reinforcing member fixing unit 430 is connected (joined) to at least one of the pair of restraint bodies (the first restraint body 210 and the second restraint body 220) included in the energy storage unit 200, whereby the reinforcing member 400 is fixed to at least one of the pair of restraint bodies. In the embodiment, the reinforcing member fixing unit 430 is connected (joined) to a second restraint body fixing unit 226 of the second restraint body 220 to be described later, whereby the reinforcing member 400 is fixed to the second restraint body 220 (energy storage unit 200) (see FIGS. 5 and 7).

Specifically, the plurality of reinforcing member fixing units 430 are arranged at substantially equal intervals in the X-axis direction between the two reinforcing member protrusions 410 and between the reinforcing member protrusions 410 and 420. The plurality of second restraint body fixing units 226 are arranged at positions corresponding to the reinforcing member fixing units 430 of the second restraint body 220. The arrangement positions and the numbers of the reinforcing member fixing units 430 and the second restraint body fixing units 226 are not particularly limited.

The second restraint body fixing unit 226 is a bolt portion, and the reinforcing member fixing unit 430 is a nut portion to which the bolt portion is screwed. That is, the second restraint body fixing unit 226 includes a male screw portion in which a screw thread is formed in a columnar portion, and the reinforcing member fixing unit 430 includes a through-hole and a nut disposed on the through-hole (see FIG. 7). The reinforcing member fixing unit 430 may be a bolt portion, and the second restraint body fixing unit 226 may be a nut portion to which the bolt portion is screwed. The technique of fixing the reinforcing member 400 to the second restraint body 220 (energy storage unit 200) may be another technique, and may be welding, caulked joining, adhesion, welding, or the like.

[2 Description of Configuration of Energy Storage Unit 200]

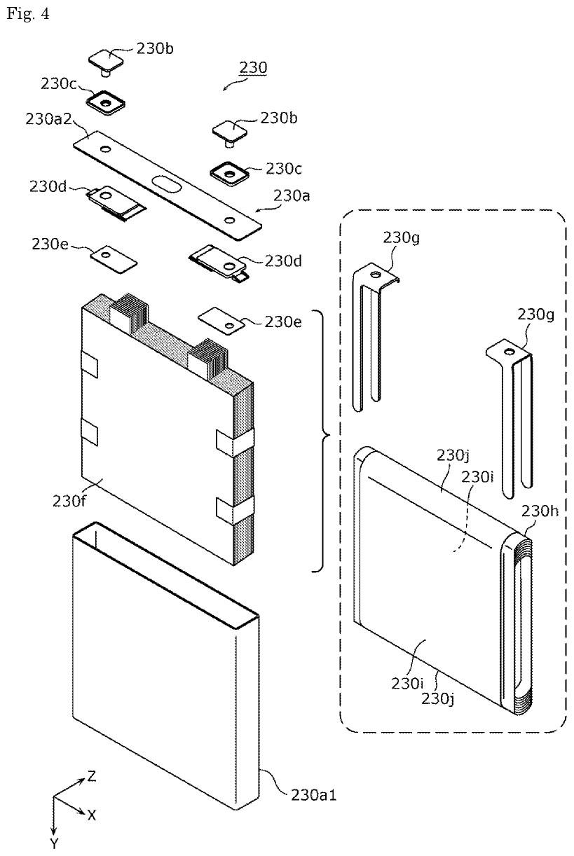

A configuration of the energy storage unit 200 will be described in detail below. FIG. 3 is an exploded perspective view illustrating each component when the energy storage unit 200 of the embodiment is disassembled. FIG. 4 is an exploded perspective view illustrating each component when the energy storage device 230 of the embodiment is disassembled. Specifically, FIG. 4 is an exploded view illustrating respective portions of the energy storage device 230 in FIG. 3 while the energy storage device 230 is vertically disposed (erected).

FIG. 5 is a sectional view illustrating the configuration of the energy storage unit 200 of the embodiment together with the reinforcing member 400. Specifically, FIG. 5 illustrates a configuration where the state where the reinforcing member 400 is fixed to the energy storage unit 200 is cut along a plane parallel to an XZ-plane at the position of the line V-V in FIG. 1. FIG. 6 is a sectional view illustrating the configuration of the energy storage unit 200 of the embodiment together with the reinforcing member 400 and the outer case body 110. Specifically, FIG. 6 illustrates a configuration where the state where the energy storage unit 200 is fixed to the outer case body 110 while the reinforcing member 400 is fixed to the energy storage unit 200 is cut along a plane parallel to the XZ-plane at the position of the line VI-VI in FIG. 1. FIG. 7 is a sectional view illustrating the configuration of the energy storage unit 200 of the embodiment together with other components. Specifically, FIG. 7 illustrates the configuration when the energy storage apparatus 10 in FIG. 1 is cut along a plane parallel to a YZ-plane passing through a line VII-VII.

As illustrated in FIG. 3, the energy storage unit 200 includes the first restraint body 210 and the second restraint body 220 that are the pair of restraint bodies, the energy storage devices 230, the electric device 240, and a spacer 250. The energy storage unit 200 also includes the bus bar or the like electrically connecting the energy storage devices 230 to each other, but illustration and detailed description thereof are omitted.

[2.1 Description of Configuration of Energy Storage Device 230]

First, a configuration of the energy storage device 230 will be described in detail. The energy storage device 230 is a secondary battery (battery cell) that can charge and discharge the electricity, more specifically, is a nonaqueous electrolyte secondary battery such as a lithium ion secondary battery. The energy storage device 230 has a flat rectangular parallelepiped shape (square shape), and in the embodiment, the eight energy storage devices 230 are arrayed in the Z-axis direction and the X-axis direction while the eight energy storage devices are horizontally placed (laid down) (while long side surfaces of the energy storage devices 230 face the Z-axis direction). Specifically, two first energy storage devices 231 are stacked (stacked flat) in the Z-axis direction, two second energy storage devices 232 are stacked (stacked flat) in the Z-axis direction, two third energy storage devices 233 are stacked (stacked flat) in the Z-axis direction, and two fourth energy storage devices 234 are stacked (stacked flat) in the Z-axis direction. The two first energy storage devices 231, the two second energy storage devices 232, the two third energy storage devices 233, and the two fourth energy storage devices 234 are arrayed in the X-axis direction from the X-axis negative direction toward the X-axis positive direction.

The number of the plurality of energy storage devices 230 is not particularly limited as long as the plurality of energy storage devices 230 are arranged in the X-axis direction, and any number of energy storage devices 230 may be stacked (stacked flat) in the Z-axis direction, or any number of energy storage devices 230 may be arrayed in the X-axis direction. The shape of the energy storage device 230 is not limited to the above-mentioned square shape, but may be a polygonal columnar shape, a cylindrical shape, an elliptical columnar shape, an oval columnar shape or the like other than the above-mentioned square shape. The energy storage device 230 is not limited to the nonaqueous electrolyte secondary battery, but may be a secondary battery except for the nonaqueous electrolyte secondary battery or a capacitor. The energy storage device 230 is not the secondary battery, but may be a primary battery that can use stored electricity without being charged by a user.

Because all the eight energy storage devices 230 (the two first energy storage devices 231, the two second energy storage devices 232, the two third energy storage devices 233, and the two fourth energy storage devices 234) have the same configuration, the configuration of one energy storage device 230 will be described below.

As illustrated in FIG. 4, the energy storage device 230 includes a case 230a, a pair of (positive electrode-side and negative electrode-side) electrode terminals 230b, and a pair of (positive electrode-side and negative electrode-side) upper gaskets 230c. A pair of (positive electrode-side and negative electrode-side) lower gaskets 230d, a pair of (positive electrode-side and negative electrode-side) current collectors 230e, and an electrode assembly 230f are accommodated inside the case 230a. Although an electrolytic solution (nonaqueous electrolyte) is sealed in the case 230a, the illustration is omitted. A kind of the electrolyte solution is not particularly limited as long as performance of the energy storage device 230 is not impaired, and various kinds of electrolyte solutions can be selected. A spacer disposed on the side or above the electrode assembly 230f, an insulating film enclosing the electrode assembly 230f, or the like may be disposed in addition to the above components.

As illustrated in a broken line of FIG. 4, the energy storage device 230 may include a current collector 230g and an electrode assembly 230h instead of the current collector 230e and the electrode assembly 230f. For this reason, the current collector 230e and the electrode assembly 230f will be described in the following description, but unless otherwise specified, the current collector 230e and the electrode assembly 230f in the following description can be expressed as the current collector 230g and the electrode assembly 230h.

The case 230a is a rectangular parallelepiped (square or box) case including a case body 230a1 in which the opening is formed and a case lid 230a2 that closes the opening of the case body 230a1. With such the configuration, the case 230a has a structure in which the inside can be sealed by welding the case body 230a1 and the case lid 230a2 after the electrode assembly 230f and the like are accommodated in the case body 230a1. The material of the case body 230a1 and the case lid 230a2 is not particularly limited, but is preferably weldable metal such as stainless steel, aluminum, an aluminum alloy, iron, or a plated steel plate. That is, in the embodiment, the case 230a is a metal case.

The case body 230a1 is a member including a bottom having a rectangular cylindrical shape constituting a body of the case 230a, and the opening is formed on the Y-axis negative direction side. That is, the case body 230a1 has a pair of rectangular and flat plate-shaped long side surfaces on both side surfaces in the Z-axis direction, a pair of rectangular and flat plate-shaped short side surfaces on both side surfaces in the X-axis direction, and a rectangular and flat plate-shaped bottom surface on the Y-axis positive direction side. The case lid 230a2 is a rectangular plate-like member constituting the lid of the case 230a, and is disposed to extend in the X-axis direction on the Y-axis negative direction side of the case body 230a1.

The electrode assembly 230f is an energy storage element (power generation element) formed by stacking a positive electrode plate, a negative electrode plate, and a separator. The positive electrode plate is obtained by forming a positive active material layer on a positive electrode substrate layer that is a current collecting foil made of metal such as aluminum or an aluminum alloy. The negative electrode plate is obtained by forming a negative active material layer on a negative electrode substrate layer that is a current collecting foil made of metal such as copper or a copper alloy. A known material can be appropriately used as the active material used for the positive active material layer and negative active material layer as long as the positive active material and the negative active material can store and release the lithium ion.

The electrode assembly 230f is a stacked type electrode assembly formed by stacking a plurality of flat plate-shaped positive electrode plates and a plurality of flat plate-shaped negative electrode plates. On the other hand, the electrode assembly 230h is a winding-type (what is called a vertical winding-type) electrode assembly formed by winding plates (a positive electrode plate and a negative electrode plate) around a winding axis extending in the X-axis direction. The electrode assembly of the energy storage device 230 is not limited to the above-described type of electrode assembly, but may be any form of electrode assembly such as a winding-type (what is called a horizontal winding-type) electrode assembly formed by winding the positive electrode plate and the negative electrode plate around the winding axis extending in the Y-axis direction, or a bellows-type electrode assembly formed by folding the plate in a bellows shape.

Because the plates (the positive electrode plate and the negative electrode plate) of the electrode assembly 230f are stacked in the Z-axis direction, the Z-axis direction is also referred to as a stacking direction. The electrode assembly 230f is formed by stacking the plate in the stacking direction. The electrode assembly 230h includes a pair of curved portions 230j arranged in the Y-axis direction and a pair of flat portions 230i that is arranged in the Z-axis direction and connects the pair of curved portions 230j by winding plates, and the stacking direction is a stacking direction of the plates in the flat portions 230i. The direction that the flat surface of the flat portion 230i faces or the opposing direction of the pair of flat portions 230i can also be defined as the stacking direction. For this reason, it can be said that the two first energy storage devices 231 are arranged in the stacking direction, and it can be said that the two second energy storage devices 232 are also arranged in the stacking direction. The same applies to the third energy storage device 233 and the fourth energy storage device 234.

The X-axis direction in which the first energy storage device 231, the second energy storage device 232 and the like are arrayed is also referred to as the array direction. That is, the first energy storage device 231, the second energy storage device 232 and the like are arrayed in the array direction intersecting the stacking direction. The first energy storage device 231 and the second energy storage device 232 are disposed at positions adjacent to each other in the array direction. The third energy storage device 233 is disposed at the position where the second energy storage device 232 is sandwiched between the third energy storage device 233 and the first energy storage device 231 in the array direction. The fourth energy storage device 234 is disposed at the position where the third energy storage device 233 is sandwiched between the fourth energy storage device 234 and the second energy storage device 232 in the array direction. In other words, in the array direction, the first energy storage device 231, the second energy storage device 232, the third energy storage device 233 and the fourth energy storage device 234 are arrayed in this order.

The electrode terminal 230b is a terminal (the positive electrode terminal and the negative electrode terminal) of the energy storage device 230 disposed on the case lid 230a2, and is electrically connected to the positive electrode plate and the negative electrode plate of the electrode assembly 230f through the current collector 230e. The electrode terminal 230b is made of a metal conductive member such as aluminum, an aluminum alloy, copper, and a copper alloy. The current collector 230e is a conductive member (a positive electrode current collector and a negative electrode current collector) electrically connected to the electrode terminal 230b and the electrode assembly 230f. The current collector 230e is made of aluminum, an aluminum alloy, copper, a copper alloy, or the like. The upper gasket 230c and the lower gasket 230d are flat plate-shaped sealing members having an electrical insulation property, which are disposed between the case lid 230a2 and the electrode terminal 230b and the current collector 230e. The upper gasket 230c and the lower gasket 230d are formed of an insulating member or the like similar to the outer case 100.

[2.2 Description of Configuration of Spacer 250 and Electric Device 240]

The spacer 250 is a rectangular and flat plate-shaped spacer disposed adjacent to the energy storage device 230. Specifically, the spacer 250 is disposed in the Z-axis positive direction or the Z-axis negative direction of the energy storage device 230 so as to be opposite to the long side surface of the case 230a of the energy storage device 230. In the embodiment, the spacers 250 are disposed so as to sandwich the energy storage devices 230 in the Z-axis direction, and electrically insulate the energy storage devices 230 from the adjacent energy storage devices 230, the first restraint body 210 or the second restraint body 220. The spacer 250 is formed of an insulating member similar to the outer case 100, a heat insulating member similar to the heat insulating sheet 300, or the like. Instead of the spacer 250 or in addition to the spacer 250, an insulating sheet may be disposed on the side surface of the case 230a of the energy storage device 230.

The electric device 240 is an electric item disposed in the X-axis direction (array direction) of the plurality of energy storage devices 230 such as the first energy storage device 231 and the second energy storage device 232. Specifically, the electric device 240 is disposed in the X-axis positive direction of the energy storage devices 230 (fourth energy storage device 234 on the lower side) on the most X-axis positive direction side and the Z-axis negative direction side in the plurality of energy storage devices 230. The electric device 240 includes electric components such as a circuit board, a fuse, a relay, a semiconductor switch such as a field effect transistor (FET), a shunt resistor, a thermistor, and a connector, which monitor a charge state or a discharge state of the energy storage device 230 and control charge and discharge of the energy storage device 230.

[2.3 Description of Configuration of First Restraint Body 210 and second restraint body 220]

Configurations of the first restraint body 210 and the second restraint body 220 will be described in detail below. The first restraint body 210 and the second restraint body 220 are a pair of restraint bodies that collectively sandwiches the plurality of energy storage devices 230 such as the first energy storage device 231 and the second energy storage device 232 in the Z-axis direction (the stacking direction). That is, the first restraint body 210 and the second restraint body 220 collectively sandwich the plurality of first energy storage devices 231, the plurality of second energy storage devices 232, and the like in the Z-axis direction (the stacking direction). Thus, the first restraint body 210 and the second restraint body 220 collectively restrain the plurality of energy storage devices 230 in the Z-axis direction (collectively apply restraint force in the Z-axis direction to the plurality of energy storage devices 230). The first restraint body 210 and the second restraint body 220 are formed of a metal member such as stainless steel, aluminum, an aluminum alloy, iron, or a plated steel plate, and may be formed of an insulating member such as a resin having high rigidity.

That is, each of the first restraint body 210 and the second restraint body 220 is an integrated body (integrally molded article) formed by bending one plate-like member or the like, and is directly joined to each other to collectively sandwich the plurality of energy storage devices 230. Specifically, the first restraint body 210 and the second restraint body 220 are directly joined to each other at positions where the plurality of energy storage devices 230 such as the first energy storage device 231 and the second energy storage device 232 are sandwiched in the X-axis direction (the above-described array direction). The first restraint body 210 and the second restraint body 220 are connected between the energy storage devices 230, such as the first energy storage device 231 and the second energy storage device 232, which are adjacent to each other in the X-axis direction. In the embodiment, the first restraint body 210 and the second restraint body 220 are joined directly between the energy storage devices 230, such as between the first energy storage device 231 and the second energy storage device 232 and between the second energy storage device 232 and the third energy storage device 233, which are adjacent to each other in the X-axis direction. These will be specifically described below.

The first restraint body 210 is a plate-like member that is disposed in the Z-axis negative direction of the plurality of energy storage devices 230, the plurality of spacers 250, and the electric device 240 and on which the energy storage devices 230 and the like are placed. The first restraint body 210 includes four energy storage device disposing portions 211, four first restraint body protrusions 212, and an electric device disposing portion 213. The second restraint body 220 is a plate-like member that is disposed in the Z-axis positive direction of the plurality of energy storage devices 230 and the plurality of spacers 250 and presses the energy storage devices 230 and the like. The second restraint body 220 includes four energy storage device restraint portions 221 and five second restraint body protrusions 222.

The energy storage device disposing portion 211 of the first restraint body 210 is a rectangular plate-like member parallel to the XY-plane where the energy storage devices 230 are disposed (placed) through the spacers 250. The four energy storage device disposing portions 211 are arranged in the X-axis direction while corresponding to the four energy storage devices 230 arrayed in the X-axis direction. In the embodiment, the energy storage device disposing portion 211 is disposed so as to cover the entire surface of the side surface (long side surface) on the Z-axis negative direction side of the case 230a of the energy storage device 230 (see FIG. 2).

The energy storage device restraint portion 221 of the second restraint body 220 is a rectangular plate-like portion that is parallel to the XY-plane and restrains the plurality of energy storage devices and the plurality of spacers 250 arranged in the Z-axis direction by sandwiching the plurality of energy storage devices 230 and the plurality of spacers with the energy storage device disposing portion 211. The four energy storage device restraint portions 221 are arranged in the X-axis direction while corresponding to the four energy storage device disposing portions 211 arrayed in the X-axis direction. In the embodiment, the energy storage device restraint portion 221 is disposed so as to cover the entire surface of the side surface (long side surface) on the Z-axis positive direction side of the case 230a of the energy storage device 230 (see FIG. 2).

The first restraint body protrusion 212 of the first restraint body 210 is a protrusion (protruding stripe portion) that protrudes in a swelling shape from the energy storage device disposing portion 211 toward the Z-axis positive direction and extends in the Y-axis direction. The four first restraint body protrusions 212 are disposed between the adjacent energy storage device disposing portions 211 and in the X-axis negative direction of the energy storage device disposing portion 211 on the X-axis negative direction side. The electric device disposing portion 213 is a rectangular plate-like member parallel to the XY-plane where the electric device 240 is disposed (placed). The electric device disposing portion 213 is disposed at the position protruding (one step up) in the Z-axis positive direction from the end on the X-axis positive direction side of the energy storage device disposing portion 211.

The second restraint body protrusion 222 of the second restraint body 220 is a protrusion (protruding stripe portion) that protrudes in the swelling shape from the energy storage device restraint portion 221 toward the Z-axis negative direction and extends in the Y-axis direction. The five second restraint body protrusions 222 are disposed between the adjacent energy storage device restraint portions 221, in the X-axis negative direction of the energy storage device restraint portion 221 on the X-axis negative direction side, and in the X-axis positive direction of the energy storage device restraint portion 221 on the X-axis positive direction side. That is, the five second restraint body protrusions 222 are disposed at positions opposite to the four first restraint body protrusions 212 and the end on the X-axis negative direction side of the electrical device disposing portion 213. The second restraint body protrusion 222 is formed such that the protruding amount in the Z-axis negative direction is larger than the protruding amount in the Z-axis positive direction of the first restraint body protrusion 212.

The first restraint body connection portions 217 are provided in the four first restraint body protrusions 212 and the electrical device disposing portion 213. Specifically, the two first restraint body connecting units 217 are provided at both ends in the Y-axis direction in each of the first restraint body protrusion 212 and the end on the X-axis negative direction side of the electric device disposing portion 213. Second restraint body connection portions 227 are provided in the five second restraint body protrusions 222. Specifically, in each of the second restraint body protrusions 222, the two second restraint body connection portions 227 are provided at positions corresponding to the first restraint body connection portions 217 at both ends in the Y-axis direction.

The second restraint body connection portion 227 is connected (joined) to the first restraint body connection portion 217, whereby the second restraint body 220 is fixed to the first restraint body 210. Specifically, as illustrated in FIGS. 5 and 7, the first restraint body protrusion 212 protrudes toward the second restraint body protrusion 222 of the second restraint body 220, is disposed between the first energy storage device 231 and the second energy storage device 232 or the like, and is directly joined to the second restraint body protrusion 222 of the second restraint body 220 between the first energy storage device 231 and the second energy storage device 232 or the like. The second restraint body protrusion 222 protrudes toward the first restraint body protrusion 212 of the first restraint body 210, is disposed between the first energy storage device 231 and the second energy storage device 232 or the like, and is directly joined to the first restraint body protrusion 212 of the first restraint body 210 between the first energy storage device 231 and the second energy storage device 232 and the like. The first restraint body connection portion 217 and the second restraint body connection portion 227 are joined while the first restraint body protrusion 212 and the second restraint body protrusion 222 abut on each other (the first restraint body 210 and the second restraint body 220 abut on each other). In this manner, the first restraint body 210 and the second restraint body 220 (the first restraint body protrusion 212 and the second restraint body protrusion 222) are directly joined at the positions sandwiching the plurality of energy storage devices 230 and between the adjacent energy storage devices 230 in the X-axis direction.

The direct joining between the first restraint body 210 and the second restraint body 220 is not limited to the joining in the state where the first restraint body and the second restraint body are in contact with each other, and refers to the state where the first restraint body 210 and the second restraint body 220 are joined without disposing a member that mediates force therebetween. That is, even when the first restraint body 210 and the second restraint body 220 are joined while an accessory such as a gasket or a washer is sandwiched between the first restraint body 210 and the second restraint body 220, the concept that the first restraint body 210 and the second restraint body 220 are directly joined is included.

Specifically, the second restraint body connection portion 227 is a bolt portion, and the first restraint body connection portion 217 is a nut portion to which the bolt portion is screwed. That is, the second restraint body connection portion 227 includes a through-hole and a bolt inserted into the through-hole, and the first restraint body connection portion 217 has a through-hole and a nut disposed below the through-hole (see FIG. 7). The first restraint body connection portion 217 may be a bolt portion, and the second restraint body connection portion 227 may be a nut portion to which the bolt portion is screwed. The technique of connecting (joining) the second restraint body 220 to the first restraint body 210 may be another technique, and may be welding, caulked joining, adhesion, welding, or the like. The arrangement positions and the numbers of the first restraint body connection portions 217 and the second restraint body connection portions 227 are not particularly limited.

The above-described first restraint body fixing unit 218 is provided on the four first restraint body protrusions 212 and the electrical device disposing portion 213 of the first restraint body 210. Specifically, the two first restraint body fixing units 218 are provided on the outside in the Y-axis direction of the two first restraint body connection portions 217 at each of the first restraint body protrusion 212 and the end on the X-axis negative direction side of the electrical device disposing portion 213 (see FIG. 7).

As described above, the first restraint body fixing unit 218 is a member fixed to the outer case body 110 of the outer case 100. That is, as illustrated in FIG. 6, the first restraint body fixing unit 218 is fixed to the outer case fixing unit 112 of the outer case body 110 at the position where the plurality of energy storage devices 230 are sandwiched and between the adjacent energy storage devices 230 in the X-axis direction. In this manner, the first restraint body 210 is fixed to the outer case 100 at the position where the plurality of energy storage devices 230 such as the first energy storage device 231 and the second energy storage device 232 are sandwiched in the X-axis direction. The first restraint body 210 is fixed to the outer case 100 between the energy storage devices 230 adjacent to each other in the X-axis direction such as between the first energy storage device 231 and the second energy storage device 232.

The above-described second restraint body fixing units 226 are provided in the four energy storage device restraint portions 221 of the second restraint body 220. Specifically, in each of the energy storage device restraint portions 221, the two second restraint body fixing units 226 are arranged at the center portion at the X-axis direction. As described above, the second restraint body fixing unit 226 is a member to which the reinforcing member 400 is fixed, and is a cylindrical bolt portion that protrudes in the Z-axis positive direction from the energy storage device restraint portion 221. That is, as illustrated in FIG. 5, the reinforcing member fixing unit 430 of the reinforcing member 400 is connected (joined) to the second restraint body fixing unit 226, whereby the reinforcing member 400 is fixed to the second restraint body 220. Thus, the reinforcing member 400 is disposed in the Z-axis positive direction (the stacking direction) of the plurality of energy storage devices 230 such as the first energy storage device 231 and the second energy storage device 232. The reinforcing member protrusions 410 and 420 are members that protrude in the Z-axis positive direction (the stacking direction) and extend in the X-axis direction (the array direction).

The reinforcing member 400 is formed such that at least one of the first energy storage device 231 and the second energy storage device 232 does not protrude from the reinforcing member 400 in the X-axis direction (the array direction). That is, the reinforcing member 400 is formed so as to extend to at least the end edge in the X-axis direction of at least one of the first energy storage device 231 and the second energy storage device 232 in the X-axis direction. In other words, at least a part of the reinforcing member 400 overlaps the end edge of at least one of the first energy storage device 231 and the second energy storage device 232 in the X-axis direction as viewed in the Z-axis direction.

In the embodiment, the reinforcing member 400 is formed such that both the first energy storage device 231 and the second energy storage device 232 do not protrude from the reinforcing member 400 in the X-axis direction. Specifically, the reinforcing member 400 is formed such that all the energy storage devices 230 do not protrude from the reinforcing member 400 in the X-axis direction. That is, in the X-axis direction, the reinforcing member 400 is formed so as to have a length equal to or longer than a length from the end edge on the X-axis negative direction side of the first energy storage device 231 to the end edge on the X-axis positive direction side of the fourth energy storage device 234.

More specifically, the reinforcing member 400 is formed such that the electric device 240 does not protrude from the reinforcing member 400 in the X-axis direction (the array direction). That is, the reinforcing member 400 is formed so as to extend to at least the end edge in the X-axis direction of the electric device 240 in the X-axis direction. In other words, at least a part of the reinforcing member 400 overlaps the end edge in the X-axis direction of the electric device 240 when viewed from the Z-axis direction.

In the embodiment, the reinforcing member 400 is formed to have substantially the same length as the first restraint body 210 in the X-axis direction. Thus, the reinforcing member 400 protrudes more than all the energy storage devices 230 and the electric device 240 on both sides in the X-axis direction. As described above, the plurality of energy storage devices 230 have the configurations in which the plurality of energy storage devices 230 are protected by the first restraint body 210 on the Z-axis negative direction side and protected by the second restraint body 220 and the reinforcing member 400 on the Z-axis positive direction side. The electric device 240 is protected by the first restraint body 210 on the Z-axis negative direction side and protected by the reinforcing member 400 on the Z-axis positive direction side. The reinforcing member 400 may be longer or slightly shorter than the first restraint body 210 in the X-axis direction.

The length in the Y-axis direction of the reinforcing member 400 is not particularly limited, but in the embodiment, the reinforcing member 400 is formed to have substantially the same length as the first restraint body 210 also in the Y-axis direction. Accordingly, the reinforcing member 400 protrudes further than all the energy storage devices 230 and the electric device 240 even on both sides in the Y-axis direction. Thus, also in the Y-axis direction, the plurality of energy storage devices 230 and the electric device 240 are protected by the first restraint body 210 on the Z-axis negative direction side and protected by the reinforcing member 400 on the Z-axis positive direction side. The reinforcing member 400 may be longer or shorter than the first restraint body 210 in the Y-axis direction.

Similarly to the reinforcing member 400, the reinforcing member protrusions 410 and 420 are formed such that at least one of the first energy storage device 231 and the second energy storage device 232 does not protrude from the reinforcing member protrusions 410 and 420 in the X-axis direction (the array direction). That is, the reinforcing member protrusions 410 and 420 are formed so as to extend to at least the end edges in the X-axis direction of at least one of the first energy storage device 231 and the second energy storage device 232 in the X-axis direction. In other words, at least a part of the reinforcing member protrusions 410 and 420 overlaps the end edge in the X-axis direction of at least one of the first energy storage device 231 and the second energy storage device 232 as viewed in the Z-axis direction.

The reinforcing member protrusion 410 is formed such that the electric device 240 does not protrude from the reinforcing member protrusion 410 in the X-axis direction (the array direction). That is, the reinforcing member protrusion 410 is formed so as to extend to at least the end edge in the X-axis direction of the electric device 240 in the X-axis direction. In other words, at least a part of the reinforcing member protrusion 410 overlaps the end edge in the X-axis direction of the electric device 240 as viewed in the Z-axis direction.

In the embodiment, because the reinforcing member protrusion 410 is formed over the entire length of the reinforcing member 400 in the X-axis direction, similarly to the reinforcing member 400, the reinforcing member protrusion 410 protrudes more than all the energy storage devices 230 and the electric device 240 on both sides in the X-axis direction. The length of the reinforcing member protrusion 420 in the X-axis direction is shorter than the length of the reinforcing member protrusion 410, and the reinforcing member protrusion 420 protrudes more than all the energy storage devices 230 on both sides in the X-axis direction. In the embodiment, the reinforcing member protrusion 420 does not protrude more than the electric device 240, but may be configured to protrude more than the electric device 240.

[3 Description of Effects]

As described above, according to the energy storage apparatus 10 of the embodiment of the present invention, the energy storage devices 230 such as the first energy storage device 231 and the second energy storage device 232 include the metal cases 230a, and are arrayed in the array direction (X-axis direction) that intersects the stacking direction (Z-axis direction) of the plate of the electrode assembly 230f. The pair of restraint bodies (the first restraint body 210 and the second restraint body 220) is directly joined to collectively sandwich the energy storage devices 230 such as the first energy storage device 231 and the second energy storage device 232 in the stacking direction.

The energy storage devices 230 such as the first energy storage device 231 and the second energy storage device 232 swell in the stacking direction of the plate of the electrode assembly 230f. For this reason, when the energy storage devices 230 such as the first energy storage device 231 and the second energy storage device 232 are arrayed in the array direction intersecting the stacking direction, the swelling is required to be prevented for all the energy storage devices 230 such as the first energy storage device 231 and the second energy storage device 232. However, when the first energy storage device 231, the second energy storage device 232, and the like are individually sandwiched by the restraint bodies, the configuration becomes complicated. Accordingly, the configuration can be simplified by sandwiching the energy storage devices 230 such as the first energy storage device 231 and the second energy storage device 232 at once by the pair of restraint bodies.

The energy storage device 230 such as the first energy storage device 231 and the second energy storage device 232 includes the metal case 230a in order to prevent the swelling. However, because the case 230a is swollen even when the case 230a is made of metal, the energy storage device 230 is required to be firmly held with the pair of restraint bodies. However, when the pair of restraint bodies is joined through another member, the number of joining places increases, and the risk of loosening the joining places increases. Thus, the pair of restraint bodies is directly joined. Thus, it is possible to reduce the risk that the number of joining places is reduced to loosen the joining portions, and the number of components can also be reduced, so that the configuration can be simplified.

As described above, in the configuration in which the plurality of energy storage devices 230 (the first energy storage device 231, the second energy storage device 232, and the like) are sandwiched between the pair of restraint bodies in the direction intersecting the array direction of the energy storage devices 230, the swelling of the plurality of energy storage devices 230 can be easily prevented.

The pair of restraint bodies is directly joined at the positions where the energy storage devices 230 such as the first energy storage device 231 and the second energy storage device 232 are sandwiched in the array direction, so that the energy storage devices 230 such as the first energy storage device 231 and the second energy storage device 232 can be easily and collectively sandwiched. Thus, the swelling of the plurality of energy storage devices 230 (the first energy storage device 231, the second energy storage device 232, and the like) can be easily prevented by the pair of restraint bodies.

The pair of restraint bodies is directly joined between the first energy storage device 231 and the second energy storage device 232, so that each of the first energy storage device 231 and the second energy storage device 232 can be sandwiched easily and more firmly. Thus, the swelling of the plurality of energy storage devices 230 (the first energy storage device 231 and the second energy storage device 232) can be easily prevented by the pair of restraint bodies. The same applies to the third energy storage device 233 and the fourth energy storage device 234.

The protrusion (the first restraint body protrusion 212 and the second restraint body protrusion 222) is formed in at least one of the pair of restraint bodies and joined to the other restraint body, so that the pair of restraint bodies can be directly joined between the first energy storage device 231 and the second energy storage device 232 with the simple configuration. Consequently, the swelling of the plurality of energy storage devices 230 (the first energy storage device 231 and the second energy storage device 232) can be easily prevented.

The pair of restraint bodies is also directly joined between the second energy storage device 232 and the third energy storage device 233, so that each of the first energy storage device 231, the second energy storage device 232, and the third energy storage device 233 can be sandwiched easily and more firmly. Consequently, the swelling of the plurality of energy storage devices 230 (the first energy storage device 231, the second energy storage device 232, and the third energy storage device 233) can be easily prevented by the pair of restraint bodies.

In the configuration in which the plurality of first energy storage devices 231 and the plurality of second energy storage devices 232 are arranged in the stacking direction, the pair of restraint bodies collectively sandwiches the plurality of first energy storage devices 231 and the plurality of second energy storage devices 232 in the stacking direction. Consequently, the plurality of first energy storage devices 231 and the plurality of second energy storage devices 232 can be easily and collectively sandwiched between the pair of restraint bodies, so that the swelling of the plurality of first energy storage devices 231 and the plurality of second energy storage devices 232 can be easily prevented. The same applies to the third energy storage device 233 and the fourth energy storage device 234.

At least one of the pair of restraint bodies is fixed to the outer case 100, so that the energy storage devices 230 such as the first energy storage device 231 and the second energy storage device 232 can be easily fixed to the outer case 100. Consequently, even when vibration, impact, or the like is applied to the energy storage apparatus 10, the movement of the energy storage devices 230 such as the first energy storage device 231 and the second energy storage device 232 can be prevented in the outer case 100.

At least one of the pair of restraint bodies is fixed to the outer case 100 between the first energy storage device 231 and the second energy storage device 232, so that the first energy storage device 231 and the second energy storage device 232 can be fixed to the outer case 100 in a well-balanced manner. Consequently, even when the vibration, the impact, or the like is applied to the energy storage apparatus 10, the movement of the first energy storage device 231 and the second energy storage device 232 can be more prevented in the outer case 100. The same applies to the third energy storage device 233 and the fourth energy storage device 234.

The energy storage devices 230 such as the first energy storage device 231 and the second energy storage device 232 are arrayed in the array direction (X-axis direction) that intersects the stacking direction (Z-axis direction) of the plate of the electrode assembly 230f, and the reinforcing member 400 includes the reinforcing member protrusions 410 and 420 that protrude in the stacking direction and extend in the array direction. When the energy storage devices 230 such as the first energy storage device 231 and the second energy storage device 232 are arrayed in the array direction that intersects the stacking direction of the plate of the electrode assembly 230f, there is a possibility that strength in the array direction becomes weak because the length in the array direction becomes long. For this reason, the reinforcing member 400 is disposed in the stacking direction of the energy storage devices 230 such as the first energy storage device 231 and the second energy storage device 232, and the reinforcing member protrusions 410 and 420 that protrude in the stacking direction and extend in the array direction are provided in the reinforcing member 400. Thus, the strength in the arrangement direction of the reinforcing member 400 can be improved, so that protection of the energy storage devices 230 such as the first energy storage device 231 and the second energy storage device 232 can be improved in the array direction.

The reinforcing member 400 can also protect the side of the reinforcing member 400 of the energy storage devices 230 such as the first energy storage device 231 and the second energy storage device 232 in the stacking direction. In particular, the reinforcing member 400 is a corrugated plate and can absorb the force in the stacking direction, so that the protection of the first energy storage device 231 and the second energy storage device 232 can be also improved in the stacking direction.

The reinforcing member 400 is a metal (conductive) member, so that heat generated from the energy storage devices 230 such as the first energy storage device 231 and the second energy storage device 232 can be radiated. In particular, the reinforcing member 400 is the corrugated plate and a space is formed on the side of the energy storage device 230, so that the heat can be radiated by moving air heated by the heat through the space. Because the reinforcing member 400 is the corrugated plate, the reinforcing member 400 can be easily manufactured and can be reduced in weight.

Because the reinforcing member 400 is formed such that at least one of the first energy storage device 231 and the second energy storage device 232 does not protrude in the array direction, the reinforcing member 400 receives the force due to the impact or the like when the impact or the like is applied in the array direction from the outside. Thus, the strength of the first energy storage device 231 and the second energy storage device 232 can be further improved in the array direction, so that the protection of the first energy storage device 231 and the second energy storage device 232 can be further improved in the array direction. The same applies to the third energy storage device 233 and the fourth energy storage device 234.

The reinforcing member protrusions 410 and 420 are formed such that at least one of the first energy storage device 231 and the second energy storage device 232 does not protrude in the array direction. Therefore, when the impact or the like is applied in the array direction from the outside, the member of the reinforcing member 400 that is reinforced by forming the reinforcing member protrusions 410 and 420 receives the force due to the impact or the like. Thus, the strength of the first energy storage device 231 and the second energy storage device 232 can be further improved in the array direction, so that the protection of the first energy storage device 231 and the second energy storage device 232 can be further improved in the array direction. The same applies to the third energy storage device 233 and the fourth energy storage device 234.

Because the reinforcing member 400 is formed such that the electric device 240 does not protrude in the array direction, the reinforcing member 400 receives the force due to the impact or the like when the impact or the like is applied from the outside in the array direction toward the electric device 240. Thus, the electric device 240 can be protected from the force due to the impact or the like in the array direction. The reinforcing member protrusions 410 and 420 are also formed such that the electric device 240 does not protrude in the array direction, so that the protection of the electric device 240 can be further improved as described above.

The reinforcing member 400 can protect the side of the reinforcing member 400 of the electric device 240 also in the stacking direction. In particular, the reinforcing member 400 is the corrugated plate and can absorb the force in the laminating direction, the protection of the electric device 240 can be improved also in the stacking direction.

The reinforcing member 400 is fixed to at least one of the pair of restraint bodies that collectively sandwiches the energy storage devices 230 such as the first energy storage device 231 and the second energy storage device 232, so that the reinforcing member 400 can be fixed to the energy storage devices 230 such as the first energy storage device 231 and the second energy storage device 232. Thus, displacement of the reinforcing member 400 with respect to the energy storage devices 230 such as the first energy storage device 231 and the second energy storage device 232 can be prevented, so that the energy storage devices 230 such as the first energy storage device 231 and the second energy storage device 232 can be protected with more certainty.

In order to more firmly restraint the first energy storage device 231 and the second energy storage device 232, the pair of restraint bodies is connected between the first energy storage device 231 and the second energy storage device 232. However, in this case, because the gap between the first energy storage device 231 and the second energy storage device 232 becomes large, the strength in the array direction of the first energy storage device 231 and the second energy storage device 232 becomes weak. Thus, high effect is obtained such that the reinforcing member protrusions 410 and 420 are formed in the reinforcing member 400 to improve the strength in the array direction and such that the protection of the first energy storage device 231 and the second energy storage device 232 is improved in the array direction. The same applies to the third energy storage device 233 and the fourth energy storage device 234.

[4 Description of Modifications]

Although the energy storage apparatus 10 of the embodiment of the present invention is described above, the present invention is not limited to the embodiment. That is, the embodiment disclosed herein is illustrative in all respects and is not restrictive, and the scope of the present invention includes all modifications within the meaning and scope equivalent to the claims.

In the embodiment, the first restraint body 210 and the second restraint body 220 are joined to each other at the position sandwiching the plurality of energy storage devices 230 and between the adjacent energy storage devices 230 in the X-axis direction. However, the first restraint body 210 and the second restraint body 220 may be joined at any position, may not be joined at one of or both the positions sandwiching the plurality of energy storage devices 230, and may not be joined between the adjacent energy storage devices 230.

In the above embodiment, the first restraint body 210 and the second restraint body 220 are configured as separate bodies. However, the first restraint body 210 and the second restraint body 220 may be an integrated body in which one end side in the X-axis direction or one end side in the Y-axis direction is connected. That is, the first restraint body 210 and the second restraint body 220 may be formed by bending one plate-like member, and the ends that are not connected may be joined to each other.

In the embodiment, the energy storage apparatus 10 includes the plurality of first energy storage devices 231, the plurality of second energy storage devices 232, and the like arranged in the Z-axis direction, and the first restraint body 210 and the second restraint body 220 collectively sandwich the plurality of first energy storage devices 231, the plurality of second energy storage devices 232, and the like in the Z-axis direction. However, the energy storage apparatus 10 may include only one first energy storage device 231, one second energy storage device 232, and the like in the Z-axis direction, and the first restraint body 210 and the second restraint body 220 may collectively sandwich the one first energy storage device 231, the one second energy storage device 232, and the like.

In the embodiment, the first restraint body 210 and the second restraint body 220 include the protrusions (the first restraint body protrusion 212 and the second restraint body protrusion 222) protruding toward the opposite side, and the protrusions are joined to each other. However, one of the first restraint body 210 and the second restraint body 220 may include the protrusion protruding in a direction away from the other, and be joined at the protrusion or joined at a flat member without including the protrusion. That is, at least one of the pair of restraint bodies (the first restraint body 210 and the second restraint body 220) may include the protrusion that protrudes toward the other, is disposed between the first energy storage device 231 and the second energy storage device 232, and is directly joined to the other between the first energy storage device 231 and the second energy storage device 232.

In the above-mentioned embodiment, the first restraint body 210 is fixed to the outer case body 110 of the outer case 100. However, the first restraint body 210 may be fixed to the outer case lid 120. Instead of the first restraint body 210 or in addition to the first restraint body 210, the second restraint body 220 may be fixed to the outer case body 110 or the outer case lid 120. That is, at least one of the first restraint body 210 and the second restraint body 220 may be fixed to at least one of the outer case body 110 and the outer case lid 120. Both the first restraint body 210 and the second restraint body 220 may not be fixed to any of the outer case body 110 and the outer case lid 120.

In the embodiment, the first restraint body 210 is fixed to the outer case 100 at the position where the plurality of energy storage devices 230 are sandwiched and between the adjacent energy storage devices 230 in the X-axis direction. However, the first restraint body 210 may be fixed to the outer case 100 at any position, may not be fixed to the outer case 100 at one of or both the positions sandwiching the plurality of energy storage devices 230, and may not be fixed to the outer case 100 between the adjacent energy storage devices 230. Instead of the first restraint body 210 or in addition to the first restraint body 210, the second restraint body 220 may be fixed to the outer case 100.

In the case of the configuration in which at least one of the first restraint body 210 and the second restraint body 220 is fixed to the outer case 100, the energy storage device 230 may not include the metal case 230a, and a pouch type energy storage device can be used as the energy storage device 230. In this case, the first restraint body 210 and the second restraint body 220 may not be directly joined, and another member may be disposed between the first restraint body 210 and the second restraint body 220.

In the embodiment, the reinforcing member 400 is disposed in the Z-axis positive direction of the energy storage unit 200. However, the reinforcing member 400 may be disposed in the Z-axis negative direction of the energy storage unit 200, or two reinforcing members 400 may be disposed on both sides in the Z-axis direction of the energy storage unit 200.

In the above embodiment, the reinforcing member 400 is fixed to the second restraint body 220. However, the reinforcing member 400 may be fixed to the first restraint body 210. The reinforcing member 400 may not be fixed to any of the first restraint body 210 and the second restraint body 220.

In the embodiment, the reinforcing member 400 protrudes more than all the energy storage devices 230 and the electric device 240 on both sides in the X-axis direction and on both sides in the Y-axis direction. However, the energy storage device 230 or the electric device 240 may slightly protrude from the reinforcing member 400 in either the X-axis direction or the Y-axis direction. Even in this case, the energy storage device 230 and the electric device 240 can be protected as compared with the case where the reinforcing member 400 is not disposed. At least the energy storage device 230 that does not protrude from the reinforcing member 400 can be protected. Similarly, in the reinforcing member protrusions 410 and 420, the energy storage device 230 or the electric device 240 may slightly protrude from the reinforcing member 400 in the X-axis direction.

In the embodiment, the reinforcing member protrusions 410, 420 are swelling protrusions continuously and linearly extending in the X-axis direction. However, the reinforcing member protrusions 410, 420 may be protrusions in which the surface on the Z-axis positive direction side of the reinforcing member 400 protrudes in the Z-axis positive direction while the surface on the Z-axis negative direction side of the reinforcing member 400 is not recessed in the Z-axis positive direction. The reinforcing member protrusions 410, 420 may be protrusions protruding in the Z-axis negative direction. The reinforcing member protrusions 410, 420 may be a plurality of protrusions intermittently formed in the X-axis direction, or may be protrusions extending while curving in the X-axis direction instead of linearly extending in the X-axis direction. The reinforcing member protrusions 410, 420 may be protrusions extending in a direction inclined from the X-axis direction toward the Y-axis direction side.

The energy storage apparatus 10 does not need to include all the components described above. The energy storage apparatus 10 may not include the heat insulating sheet 300, the electric device 240, the spacer 250, or the like.

A form constructed by any combination of the components included in the embodiment and the modification example described above is also included in the scope of the present invention.

The present invention can be implemented not only as the energy storage apparatus 10 but also as the pair of restraint bodies (the first restraint body 210 and the second restraint body 220).

### INDUSTRIAL APPLICABILITY

The present invention can be applied to the energy storage apparatus including the energy storage device such as a lithium ion secondary battery.

### DESCRIPTION OF REFERENCE SIGNS

10: energy storage apparatus
100: outer case
110: outer case body
112: outer case fixing unit
200: energy storage unit
210: first restraint body
211: energy storage device disposing unit
212: first restraint body protrusion
213: electric device disposing unit
217: first restraint body connection unit
218: first restraint body fixing unit
220: second restraint body
221: energy storage device restraint unit
222: second restraint body protrusion
226: second restraint body fixing unit
227: second restraint body connection unit
230: energy storage device
230a: case
230f, 230h: electrode assembly
231: first energy storage device
232: second energy storage device
233: third energy storage device
234: fourth energy storage device
240: electric device
400: reinforcing member
410, 420: reinforcing member protrusion
430: reinforcing member fixing unit

1. An energy storage apparatus comprising:
two energy storage devices each of which includes an electrode assembly formed by stacking plates in a stacking direction and a metal case in which the electrode assembly is accommodated, the two energy storage devices including a first energy storage device and a second energy storage device that are arrayed in an array direction intersecting the stacking direction; and
a pair of restraint bodies that collectively sandwiches the first energy storage device and the second energy storage device in the stacking direction, the pair of restraint bodies being directly joined to each other.

2. The energy storage apparatus according to claim 1, wherein the pair of restraint bodies is directly joined at a position sandwiching the first energy storage device and the second energy storage device in the array direction.

3. The energy storage apparatus according to claim 1, wherein the pair of restraint bodies is directly joined between the first energy storage device and the second energy storage device.

4. The energy storage apparatus according to claim 3, wherein at least one of the pair of restraint bodies includes a protrusion that protrudes toward an other of the pair of restraint bodies, is disposed between the first energy storage device and the second energy storage device, and is directly joined to the other of the pair of restraint bodies between the first energy storage device and the second energy storage device.

5. The energy storage apparatus according to claim 3, further comprising a third energy storage device disposed at a position where the second energy storage device is sandwiched between the third energy storage device and the first energy storage device in the array direction,
wherein the pair of restraint bodies is directly joined between the second energy storage device and the third energy storage device.

6. The energy storage apparatus according to claim 1, further comprising a plurality of the first energy storage devices arranged in the stacking direction and a plurality of the second energy storage devices arranged in the stacking direction,
wherein the pair of restraint bodies collectively sandwiches the plurality of first energy storage devices and the plurality of second energy storage devices in the stacking direction.

7. The energy storage apparatus according to claim 1, further comprising an outer case that accommodates the first energy storage device and the second energy storage device,
wherein at least one of the pair of restraint bodies is fixed to the outer case.

8. An energy storage apparatus comprising:
two energy storage devices each including an electrode assembly formed by stacking plates in a stacking direction, the two energy storage devices including a first energy storage device and a second energy storage device that are arrayed in an array direction intersecting the stacking direction;
a pair of restraint bodies that collectively sandwiches the first energy storage device and the second energy storage device in the stacking direction, the pair of restraint bodies being joined to each other; and
an outer case that accommodates the first energy storage device and the second energy storage device, wherein
at least one of the pair of restraint bodies is fixed to the outer case.

9. The energy storage apparatus according to claim 8, wherein at least one of the pair of restraint bodies is fixed to the outer case between the first energy storage device and the second energy storage device.
